(19) United States
(12) Patent Application Publication
(10) Pub. No.: US 2025/0203555 A1
(43) Pub. Date: Jun. 19, 2025

(54) FINDING A STA LOCATION WITH AMP DEVICES

(71) Applicant: Cisco Technology, Inc., San Jose, CA (US)

(72) Inventors: Ugo M. CAMPIGLIO, Morges (CH); Jerome HENRY, Pittsboro, NC (US); Domenico FICARA, Essertines-Sur-Yverdon (CH); Indermeet S. GANDHI, San Jose, CA (US); Robert E. BARTON, Richmond (CA); Matthew A. SILVERMAN, Shaker Heights, OH (US)

(21) Appl. No.: 18/587,321

(22) Filed: Feb. 26, 2024

Related U.S. Application Data
(60) Provisional application No. 63/610,350, filed on Dec. 14, 2023.

(51) Int. Cl. H04W 64/00; H04W 56/00

(52) U.S. Cl. CPC H04W 64/00; H04W 56/001

(57) ABSTRACT

Embodiments herein use Ambient Power stations (AMP STA) to help a Wi-Fi device to identify its location where other location services may not be available, or to aid other location services. The Wi-Fi device uses a location application to transmit at least two frames to one or more AMP STAs. The AMP STAs receive a first frame and a second frame. The Wi-Fi device instructs the AMP STAs to capture timestamps for the first frame and the second frame. A third timestamp is captured once the Wi-Fi device receives the first timestamp and the second timestamp from the AMP STAs. A distance is determined from the Wi-Fi device and the AMP STAs based on the first timestamp, the second timestamp, and the third timestamp.

### CROSS-REFERENCE TO RELATED APPLICATIONS

This application claims benefit of co-pending U.S. provisional patent application Ser. No. 63/610,350 filed Dec. 14, 2023. The aforementioned related patent application is herein incorporated by reference in its entirety.

### TECHNICAL FIELD

Embodiments presented in this disclosure generally relate to using Ambient Power stations (AMP STA) to help a Wi-Fi device to identify its location where other location services may not available or to supplement other location services.

### BACKGROUND

In the IEEE 802.11 working group, the AMP study group is considering the integration of AMP STAs into Wi-Fi networks. Generally, a system transmits energy that AMP STAs receive and use for their own transmissions. In one form, the AMP STA is entirely passive, and merely reflects (thus in real time) the energy (referred to as backscattering). In another form, the AMP STA can accumulate the energy in an energy storage component, such as a capacitor, until reaching a threshold at which transmission becomes possible (thus transmission is not concurrent to the received Wi-Fi signal, but can still happen at any time after enough energy has accumulated).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a system with a Wi-Fi device and a plurality of AMP STAs, according to one embodiment.

FIG. 2 is flowchart for using a plurality of AMP STAs to identify a Wi-Fi device location, according to one embodiment.

FIG. 3 illustrates a timing chart of a Wi-Fi device communicating with an AMP STA, according to one embodiment.

FIG. 4 is flowchart for using a plurality of AMP STAs to determine the distance from a Wi-Fi device, according to one embodiment.

FIG. 5 is flowchart for using timestamps captured by a plurality of AMP STAs to determine the distance from a Wi-Fi device, according to one embodiment.

FIG. 6 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method comprising: transmitting a first frame from a Wi-Fi device to an Ambient Power Station (AMP STA), wherein the first frame instructs the AMP STA to reset a counter or capture a current timestamp of a clock; and transmitting a second frame from the Wi-Fi device to the AMP STA, wherein the second frame instructs the AMP STA to capture a first timestamp of the counter or the clock; receiving, at the Wi-Fi device, data from the AMP STA comprising at least the first timestamp and a second timestamp of the counter or clock indicating when the AMP STA transmitted the data to the Wi-Fi device; capturing a third timestamp at the Wi-Fi device when the Wi-Fi device receives the data from the AMP STA; and determining a distance from the Wi-Fi device and the AMP STA based on the first, second, and third timestamps.

Another embodiment presented in this disclosure is a Wi-Fi device that includes a processor, an antenna and a location application. The location application configured to send a first message to an Ambient Power Station (AMP STA); send a second message to the AMP STA; receive a response from the AMP STA; determine a distance between the Wi-Fi device and the AMP STA; determine a location of the AMP STA; and determine a location of the Wi-Fi.

Another embodiment presented in this disclosure is a non-transitory computer readable storage medium comprising computer readable program code embodied therewith, the computer readable program code executable by a location application to perform an operation. The operation includes determining a Wi-Fi device does not have a GPS, wherein a plurality of AMP STAs configured to receive a first message and a second message and calculating a location of a Wi-Fi device.

### EXAMPLE EMBODIMENTS

Embodiments herein use Ambient Power stations (AMP STAs) to help a Wi-Fi device (e.g., client devices such as smartphones, tablets, laptops, etc.) to identify its location where other location services (e.g., GPS) may not be available, or to supplement other location services. AMP STAs can include counters and can receive instructions from the Wi-Fi device to start the counters or to capture timestamps.

In one example, the AMP STAs can be spread out in a building (e.g., a parking garage) and be assigned accurate locations (GPS coordinates or a position relative to the AMP in the building). The Wi-Fi device can query the AMP STAs to start counters where the value of those counters can be used to identify the Wi-Fi device's distance from the AMP STAs. Those distances can be used to triangulate the location of the Wi-Fi device relative to the AMP STA. Since the AMP STA's location is known, then the location of the Wi-Fi device can be determined.

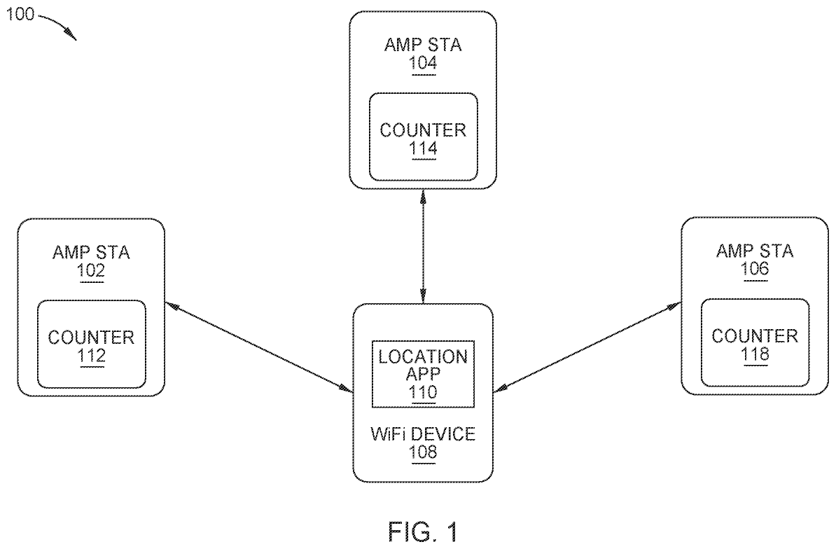

FIG. 1 illustrates a system 100 with a Wi-Fi device 108 and a plurality of AMP STAs (102, 104, 106), according to one embodiment. Each of the AMP STAS comprises a counter (112, 114, 118), wherein the counter can be a clock. The Wi-Fi device 108 comprises a location application 110 that handles the communications of the Wi-Fi device and the plurality of AMP STAs. Each of the AMP STAs are able to receive and send information to the Wi-Fi device 108. Each AMP STA is aware of its location (e.g., each AMP STA has relative or absolute coordinates that were programmed at installation).

The location application 110 of the Wi-Fi device 108 communicates with the three AMP STAs. The three AMP STAs have known locations (e.g., GPS coordinates or a offset relative to an AP) that were determined, for example, when the three AMP STAs were installed. The known locations of the three AMP STAs can be used to determine the location of the Wi-Fi device 108 after triangulation is performed. However, in another embodiment, part of the functions performed by the location application 110 can be performed on another computer device besides the Wi-Fi Device 108. For example, once the location application 110 has determined the distances to the AMP STAs (as discussed in more detail below), it can offload the triangulation to a different device or system such as a local or cloud service that is aware of the physical locations of the AMP STAs.

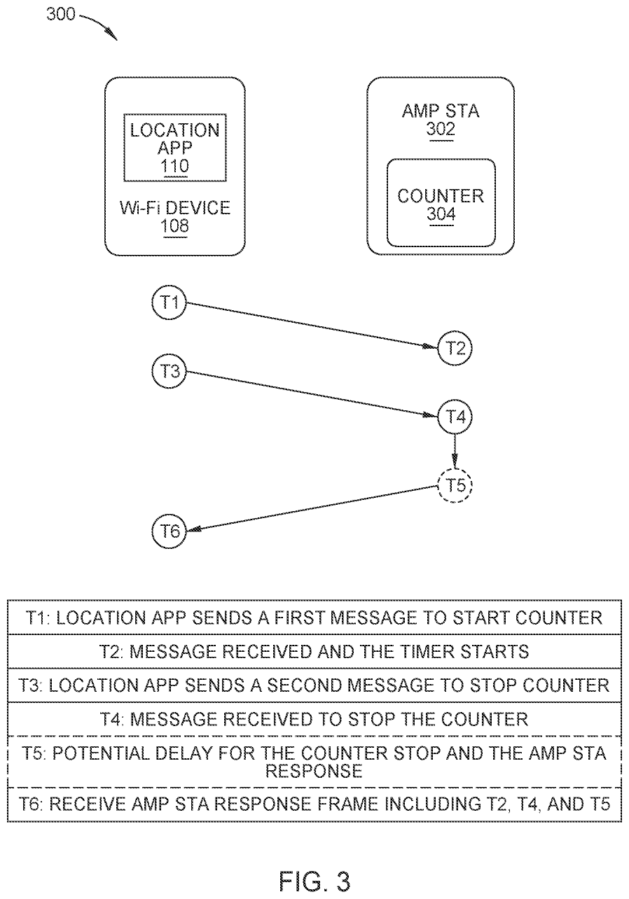

The location application 110 communicates with the three AMP STAs to obtain timestamps that indicate the distance from the Wi-Fi device 108 to each of the AMP STAs. In one embodiment, the location application 110 transmits a series of messages to each AMP STA. The messages have commands for the counter to start and to capture timestamps or values of the counter. The AMP STAs can then transmit these timestamps or counter values back to the Wi-Fi device 108 which can be used identify the distance from the Wi-Fi device 108 to the AMP STAs. Further details on how to determine the distance of the Wi-Fi device are described in FIG. 3. In some cases the Wi-Fi device 108 does not have enough power to energize the AMP STA. In that scenario, an access point (AP) can be used to energize the AMP STA if the Wi-Fi device does not have enough power to energize the AMP STA for communication.

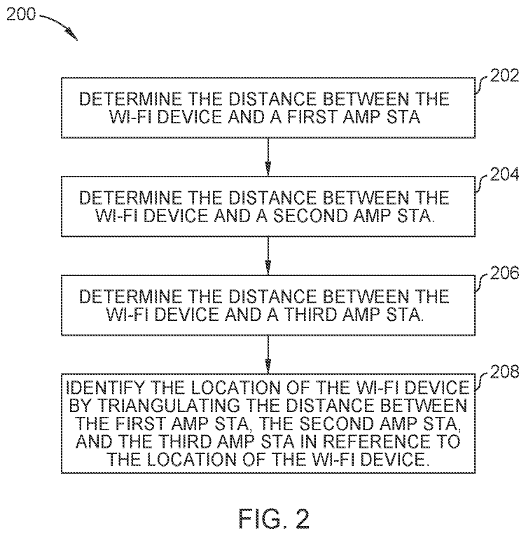

FIG. 2 is flowchart of a method 200 for using a plurality of AMP STAs to identify a Wi-Fi device location, according to one embodiment. The method 200 can be used with active AMP STAs and passive AMP STAs. The method 200 begins at block 202.

At block 202, the location application, such as the location application 110 of FIG. 1, determines the distance between a Wi-Fi device, such as the Wi-Fi device 108 of FIG. 1, and a first AMP STA, such as the AMP STA 102 of FIG. 1. In another embodiment, the Wi-Fi device sends a message to the first AMP STA with instructions to execute by the counter to start a clock, which is then used to determine the distance between the Wi-Fi device and the first AMP STA. The details for determining this distance are described in FIG. 3.

In other embodiments, instead of instructing the AMP STA to start a counter, the AMP STA may have a timer already running (e.g., a clock). The Wi-Fi device can instruct the AMP STA to capture timestamps of the timer which then can be used, similar to a counter, to determine the distance between the Wi-Fi device and the first AMP STA.

At block 204, the location application determines the distance between the Wi-Fi device and a second AMP STA, such as the AMP STA 104 of FIG. 1. The Wi-Fi device can use a counter or a timer in the second AMP STA to determine the distance as discussed in FIG. 3.

At block 206, the location application determines the distance between the Wi-Fi device and a third AMP STA, such as the AMP STA 106 of FIG. 1. The Wi-Fi device can use a counter or a timer in the third AMP STA to determine the distance as discussed in FIG. 3.

At block 208, the location application identifies the location of the Wi-Fi device by triangulating the distance between the first AMP STA, the second AMP STA, and the third AMP STA in reference to the location of the Wi-Fi device. As a simple example of triangulation, the distances between the Wi-Fi device and the three AMP STAs can be used to draw respective circles around the AMP STAs. The location of the Wi-Fi device is where the three circles intersect. While the method 200 describes using three AMP STAs, the accuracy of the location measurement may be improved if more than three AMP STAs are used.

Moreover, the method 200 could use only two AMP STAs if another location technique is also used. For example, if the Wi-Fi device determines the location between itself and two AMP STAs, when drawing circles around those AMP STAs based on the distances, there are two intersection points which is why determine the distance to at least three AMP STAs is preferred. However, another location technique may provide a rough estimate of the location of the Wi-Fi device which makes it possible to eliminate one of the intersections. With one of the intersections eliminated, the Wi-Fi device can determine that its location is the other intersection between the circles drawn around the AMP STAs.

FIG. 3 illustrates a timing chart 300 of a Wi-Fi device 108 communicating with an AMP STA 302, according to one embodiment. The Wi-Fi device 108 comprises the location application 110 and the AMP STA 302 comprises a counter 304. The timing chart 300 illustrates chronological communication between the Wi-Fi device 108 and the AMP STA 302.

At Time 1 (T1), the location application 110 sends a first message to the AMP STA 302 to start the counter 304. In another embodiment the mobile device sends a first (special) broadcast message to the AMP STA whose purpose is to reset a time counter. In one embodiment, the message is a frame that serves as a trigger, instructing the AMP STA 302 to start a counter (or to capture a timestamp using an already running clock). The frame leaves the mobile device at Time T1, and is received at the AMP device at Time 2 (T2).

At T2, the first message is received by the AMP STA 302 and the counter 304 starts. In another embodiment, at time T2, the AMP STA captures a current timestamp of a clock that is already running. It is understood that actual time the counter is started or the timestamp is captured at T2 is dependent on the AMP hardware efficiency and the software (SW) calibration which can cause inaccuracy in the distance measurement obtained from the counter 304. However, this factor is mitigated below.

At Time 3 (T3), the location application 110 sends a second message to the AMP STA 302 to stop the counter 304. In addition to stopping the counter, the message instructs the AMP STA to send the value of the counter back to the Wi-Fi device 108. The second message leaves the mobile device at time T3, and reaches the AMP device at time T4. The AMP device stops the counter at time T4.

In another embodiment, the second message instructs the AMP STA 302 to capture a second timestamp of an internal clock.

At Time 4 (T4), the second message is received by the AMP STA 302 and determines the current value of the counter 304 (and may stop the counter 304). In another embodiment, each AMP STA that is powered up and has received the two messages, sends a response to the Wi-Fi device (using unicast frames with collision avoidance). That is, while FIG. 3 illustrates the communication between the Wi-Fi device 108 and one AMP STA, the messages discussed at Times T1-T4 can be received at multiple AMP STAs in parallel.

At Time 5 (T5), a potential delay is considered for the time taken to stop the counter 304 and the AMP STA 302 to send a response to the Wi-Fi device 108. This delay can be caused by AMP hardware efficiency and the SW calibration mentioned above. This delay can vary across different AMP STAs. Moreover, in another embodiment, as channel contention is needed for the AMP response, a delay between T4 and T5 will occur between the counter stop and the AMP response. The AMP STA 302 captures a value of the counter at T5 (or a timestamp of a clock)

At Time 6 (T6), the Wi-Fi device 108 receives the AMP STA 302 response frame including the counter values (or timestamps) captured at T2, T4, T5. Further, The Wi-Fi device 108 can capture a timestamp when the frame is received from the AMP STA 302 at T6. The timestamped frames can also contain the AMP device coordinates (e.g., their known locations).

The relative distance between the Wi-Fi device 108 and the AMP STA 302 can be determined using the timestamps. In one example, the relative distance can be calculated by calculating the mean using two sets of measurements as shown in the following equation: mean (c ((T3−T1)−(T4−T2))/2, c ((T6−T3)−(T5−T4))/2).

Because obtaining the value of the counter at T4 is also dependent on the AMP hardware efficiency and the SW calibration of the AMP STA, this inaccuracy is mitigated by using the difference between the two timestamps based on the same clock and by the fact the relative distance is calculated over two sets of measurements as shown in the previous equation.

It is to be understood that though only AMP STA 302 is discussed, the timing chart 300 is used for a plurality of AMP STAs. The Wi-Fi device 108 receives timestamps and can compare the counter values or timestamps in the frame with the local timestamp captured at T6 and compute the distance from each AMP STA to the Wi-Fi device as discussed in blocks 202, 204, and 206 in FIG. 2. The coordinates of each AMP device allow calculating the mobile device location. By knowing the distance at least three AMP STAs (as well as the AMP STAs' locations), triangulation can be used to identify the location of the Wi-Fi device 108. Once the relative location of the Wi-Fi device 108 to the AMP STAs is known, the known locations of the AMP STAs can be used to determine the location of the Wi-Fi device 108.

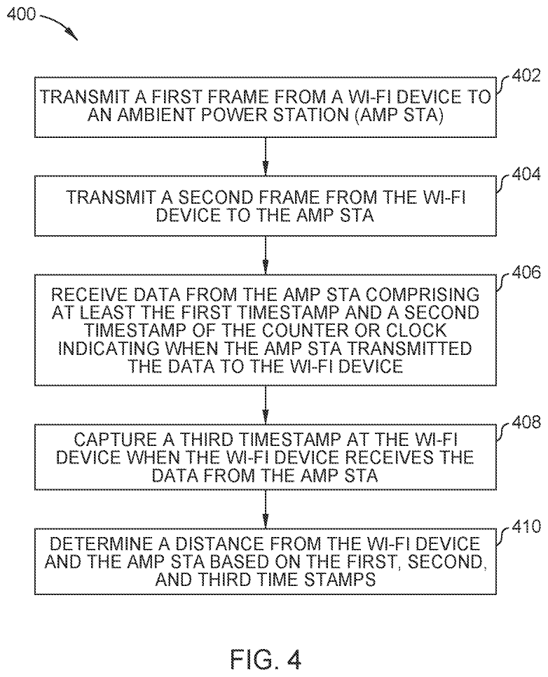

FIG. 4 is flowchart of a method 400 for using a plurality of AMP STAs to determine the distance from a Wi-Fi device, according to one embodiment. The method 400, begins at block 402.

At block 402, the location application, such as the location application 110 for FIG. 1, transmits a first frame from the Wi-Fi device, such as the Wi-Fi device 108 of FIG. 1 to an AMP STA, such as AMP STA 302 of FIG. 3. In another embodiment, the first frame transmitted from the Wi-Fi device to the AMP STA instructs a counter to start or to capture a timestamp of a clock executing on the AMP STA.

At block 404, the location application transmits a second frame from the Wi-Fi device to the AMP STA. In another embodiment, the second frame transmitted from the Wi-Fi device to the AMP STA instructs a counter to start or to capture a timestamp of a clock executing on the AMP STA.

At block 406, the Wi-Fi device receives data from the AMP STA, comprising at least the first timestamp and a second timestamp of the counter or clock, the second timestamp indicating when the AMP STA transmitted the data to the Wi-Fi device. In another embodiment, the location application, such as the location application 110 of FIG. 1, receives a response from the AMP STA with values of the counter or clock timestamps indicating when the second frame was received at the AMP STA and when the AMP STA sent the reply.

At block 408, the location application captures a third timestamp at the Wi-Fi device when the Wi-Fi device receives the data from the AMP STA comprising the third timestamp of the counter or clock indicating when the AMP STA processed the data from the Wi-Fi device.

At block 410, the location application determines a distance from the Wi-Fi device and the AMP STA based on the first timestamp, the second timestamp, and the third timestamp. In another embodiment, the location application will generate a distance between the Wi-Fi device and the AMP STA using the first timestamp, the second timestamp, and the third timestamp.

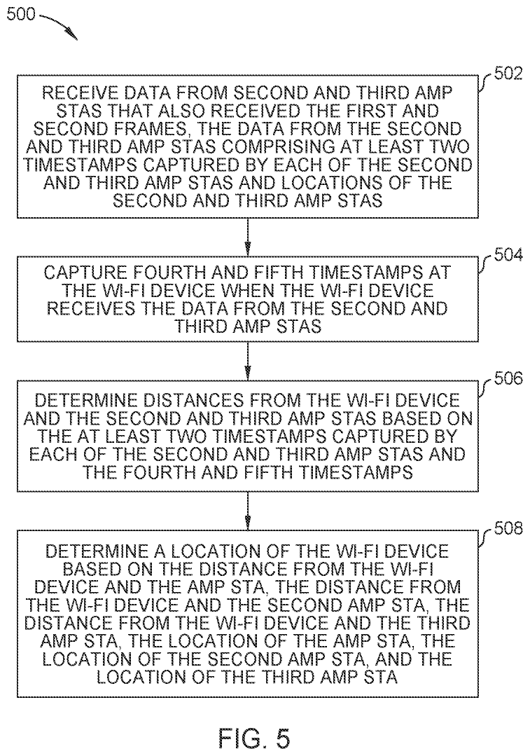

FIG. 5 is flowchart of a method 500 for using timestamps captured by a plurality of AMP STAs to determine the distance from a Wi-Fi device, according to one embodiment. The method 500 begins at block 502.

At block 502, the location application, such as the location application 110 of FIG. 1, receives data from a second and a third AMP STAs that also have received the first and second frames. The data from the second and third AMP STAs comprises at least two timestamps captured by each of the second and third AMP STAs and locations of the second and third AMP STAs. In another embodiment, the location application communicates with a second AMP STA and a third AMP STA that have already received a first and a second frame of instructions to be executed by the counter of each AMP STA. The data received from the second AMP STA and the third AMP STA may both comprise at least the two timestamps captured by the second AMP STA and the third AMP STA along with location or coordinates of the second AMP STA and the third AMP STA.

At block 504, the location application captures a fourth and a fifth timestamps at the Wi-Fi device, such as the Wi-Fi device 108 of FIG. 1, when the Wi-Fi device receives the data from the second and third AMP STAs. In one embodiment, the location application captures a fourth timestamp receives the response from the second AMP STA and captures the fifth timestamp when receiving the response from the third AMP STA.

At block 506, the location application calculates the distances from the Wi-Fi device and the second and third AMP STAs based on the at least two timestamps captured by each of the second and third AMP STAs and a fourth timestamp and a fifth timestamp. In another embodiment, the location application calculates the distance from the Wi-Fi device and the second AMP STA. The location application also calculates the distance from the Wi-Fi device and the third AMP STA. Each calculated distance uses the at least two timestamps captured by the second AMP STA, the third AMP STA, the fourth timestamp, and the fifth timestamp.

At block 508, the location application determines a location of the Wi-Fi device based on the distance from the Wi-Fi device and the AMP STA, the distance from the Wi-Fi device and the second AMP STA, the distance from the Wi-Fi device and the third AMP STA, the location of the AMP STA, the location of the second AMP STA, and the location of the third AMP STA. In another embodiment, the location application determines the location of the Wi-Fi device using the distance between the Wi-Fi device and a first AMP STA. The location application determines the distance between the Wi-Fi device and the second AMP STA. The location application determines the distance between the Wi-Fi device and the third AMP STA.

In one embodiment, because the Wi-Fi device may not know the physical locations of the AMP STAs, a different computing device or system (e.g., a cloud service) may determine the location of the Wi-Fi device using the distances calculated at block 506. Put differently, block 508 may be performed on a different device than the Wi-Fi device.

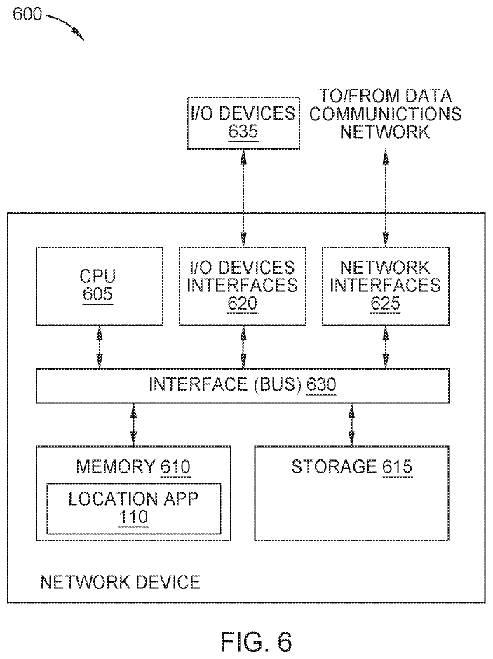

FIG. 6 depicts an example computing device (e.g., a network device 600) configured to perform various aspects of the present disclosure, according to some embodiments of the present disclosure. In some embodiments, the network device 600 corresponds to the system 100 of FIG. 1. Although depicted as a physical device, in embodiments, the network device 600 may be implemented using virtual device(s), and/or across a number of devices (e.g., in a cloud environment).

As illustrated, the network device 600 includes a CPU 605, memory 610, storage 615, a network interface 625, and one or more I/O interfaces 620. In the illustrated embodiment, the CPU 605 (e.g., one or more processors) retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the network device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated embodiment, the memory 610 includes the location application 110, which may perform one or more embodiments discussed above in FIGS. 1-5. Although depicted as discrete components for conceptual clarity, in embodiments, the operations of the depicted components (and others not illustrated) may be combined or distributed across any number of components. Further, although depicted as software residing in memory 610, in embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
transmitting a first frame from a Wi-Fi device to an Ambient Power Station (AMP STA), wherein the first frame instructs the AMP STA to start a counter or capture a current timestamp of a clock; and
transmitting a second frame from the Wi-Fi device to the AMP STA, wherein the second frame instructs the AMP STA to capture a first timestamp of the counter or the clock;
receiving, at the Wi-Fi device, data from the AMP STA comprising at least the first timestamp and a second timestamp of the counter or clock, the second timestamp indicating when the AMP STA transmitted the data to the Wi-Fi device;
capturing a third timestamp at the Wi-Fi device when the Wi-Fi device receives the data from the AMP STA; and
determining a distance from the Wi-Fi device and the AMP STA based on the first, second, and third timestamps.

2. The method of claim 1, wherein the data from the AMP STA comprises a location of the AMP STA.

3. The method of claim 2, further comprising:
receiving, at the Wi-Fi device, data from second and third AMP STAs that also received the first and second frames, the data from the second and third AMP STAs comprising at least two timestamps captured by each of the second and third AMP STAs and locations of the second and third AMP STAS;
capturing fourth and fifth timestamps at the Wi-Fi device when the Wi-Fi device receives the data from the second and third AMP STAs;
determining distances from the Wi-Fi device and the second and third AMP STAS based on the at least two timestamps captured by each of the second and third AMP STAs and the fourth and fifth timestamps; and
determining a location of the Wi-Fi device based on the distance from the Wi-Fi device and the AMP STA, the distance from the Wi-Fi device and the second AMP STA, the distance from the Wi-Fi device and the third AMP STA, the location of the AMP STA, the location of the second AMP STA, and the location of the third AMP STA.

4. The method of claim 1, wherein the first frame comprises energy for energizing the AMP STA to capture the first and second timestamps and to transmit the data to the Wi-Fi device.

5. The method of claim 1, further comprising:
before transmitting the first frame, transmitting a frame from an access point (AP) to the AMP STA that energizes the AMP STA, wherein the Wi-Fi device is a mobile device.

6. The method of claim 1, further comprising:
before transmitting the first frame, querying an AP to identify a plurality of AMP STAs to transmit the first and second frames to.

7. The method of claim 1, wherein, when the first frame instructs the AMP STA to capture the current timestamp of the clock, the data received from the AMP STA includes the current timestamp,
wherein the distance from the Wi-Fi device and the AMP STA is also based on the current timestamp.

8. A Wi-Fi device, comprising:
a processor;
memory storing a location application configured to:
send a first message to an Ambient Power Station (AMP STA) instructing the AMP STA to start a counter or capture a current timestamp of a clock;
send a second message to the AMP STA instructing the AMP STA to capture a first timestamp of the counter or the clock;
receive a response from the AMP STA comprising at least the first timestamp and a second timestamp of the counter or clock, the second timestamp indicating when the AMP STA transmitted data to the Wi-Fi device;
capture a third timestamp at the Wi-Fi device when the Wi-Fi device receives the data from the AMP STA; and
determine a distance from the Wi-Fi device and the AMP STA based on the first, second, and third timestamps.

9. The Wi-Fi device of claim 8, wherein the location application is further configured to send the first message and the second message to a second AMP STA.

10. The Wi-Fi device of claim 9, wherein the location application is further configured to send the first message and the second message to a third AMP STA.

11. The Wi-Fi device of claim 10, wherein the location application is further configured to receive a first response from the second AMP STA and a first response from the third AMP STA.

12. The Wi-Fi device of claim 11, wherein the location application is further configured to determine the distance between the Wi-Fi device and the second AMP STA.

13. The Wi-Fi device of claim 12, wherein the location application is further configured to determine the distance between the Wi-Fi device and the third AMP STA.

14. The Wi-Fi device of claim 13, wherein the location application is further configured to determine a location of the Wi-Fi device based on the distances between the Wi-Fi device and the AMP STA, the second AMP STA, and the third AMP STA.

15. The Wi-Fi device of claim 14, wherein the location application is further configured to receive a known location from at least one of the AMP STA, the second AMP, and the third AMP STA and determine the location of the Wi-Fi device with reference to the known location.

16. The Wi-Fi device of claim 15, wherein the location application is further configured to determine the distances from the Wi-Fi device and the second and third AMP STAs based on at least two timestamps captured by each of the second and third AMP STAs and a fourth timestamp and a fifth timestamp.

17. A non-transitory computer readable storage medium comprising computer readable program code embodied therewith, the computer readable program code executable by a location application to perform an operation, the operation comprising:
transmitting a first frame from a Wi-Fi device to an Ambient Power Station (AMP STA), wherein the first frame instructs the AMP STA to start a counter or capture a current timestamp of a clock; and
transmitting a second frame from the Wi-Fi device to the AMP STA, wherein the second frame instructs the AMP STA to capture a first timestamp of the counter or the clock;
receiving, at the Wi-Fi device, data from the AMP STA comprising at least the first timestamp and a second timestamp of the counter or clock, the second timestamp indicating when the AMP STA transmitted the data to the Wi-Fi device;
capturing a third timestamp at the Wi-Fi device when the Wi-Fi device receives the data from the AMP STA; and
determining a distance from the Wi-Fi device and the AMP STA based on the first, second, and third timestamps.

18. The non-transitory computer readable storage medium of claim 17, the operation further comprises a second AMP STA and a third AMP STA each comprising at least two timestamps captured by each of the second and third AMP STAs and locations of the second and third AMP STAs.

19. The non-transitory computer readable storage medium of claim 18, the operation further comprises determining distances from the Wi-Fi device and the second and third AMP STAs based on the at least two timestamps captured by each of the second AMP STA, the third AMP STA, a fourth timestamp, and a fifth timestamp.

20. The non-transitory computer readable storage medium of claim 19, the operation further comprises determining a location of the Wi-Fi device based on the distance from the Wi-Fi device and the AMP STA, the distance from the Wi-Fi device and the second AMP STA, the distance from the Wi-Fi device and the third AMP STA, the location of the AMP STA, the location of the second AMP STA, and the location of the third AMP STA.
